(19) United States
(12) Patent Application Publication
(10) Pub. No.: US 2004/0146130 A1
(43) Pub. Date: Jul. 29, 2004

(54) Apparatus and method for monitoring clock in data communication system

(76) Inventor: Moon-Soo Noh, Yongin-city (KR)

Correspondence Address: Robert E. Bushnell, Suite 300, 1522 K Street, N.W., Washington, DC, 20005, US

(21) Appl. No.: 10/751,404

(22) Filed: Jan. 6, 2004

(30) Foreign Application Priority Data
Jan. 23, 2003 (KR) 2003-4644

(51) Int. Cl. H04L 7/00

(52) U.S. Cl. 375/354

(57) ABSTRACT

An apparatus and technique for monitoring clock in a data communication system is capable of conducting a more accurate monitoring on loss of clock for a synchronous signal, to measure stability between a bus synchronous signal and a clock for matching data transmission-receiving with a higher accuracy. The clock monitoring apparatus includes a first buffer block, a first counter block, a comparison block, a pulse generation block, a second counter block, and a second buffer block. If a clock provided from a system bus is abnormal, a different value from a normal value (namely reference value, e.g. 1024) is obtained at the first counter block. In this case, the comparison block outputs a value ‘1’ to the pulse generation block, and the moment the pulse generation block receives the value ‘1’, it generates a pulse, and the second counter block counts the number of pulses generated by the pulse generation block. Based on the number of pulses generated during a monitoring cycle, it is possible to detect how many times clock has been lost. When the monitoring result is stored in the second buffer block, a system control block (i.e. CPU) reads out the stored value and figures out the stability of clock of the system. Therefore, the present invention can be advantageously used for more accurately identifying the cause of data loss and measuring the stability of synchronous and clock signals in system, by checking or monitoring any occurrence of clock loss using the synchronous signal as a reference and providing this monitoring result to the CPU.

### CLAIM OF PRIORITY

This application makes reference to, incorporates the same herein, and claims all benefits accruing under 35 U.S.C. §119 from an application for APPARATUS FOR MONITORING CLOCK OF DATA COMMUNICATION SYSTEM earlier filed in the Korean Intellectual Property Office on Jan. 23, 2003 and thereby duly assigned Serial No. 2003-4644.

### BACKGROUND OF THE INVENTION

1. Field of the Invention

The present invention relates to an apparatus for monitoring clock in data communication system, and more particularly, to an apparatus capable of conducting a more accurate monitoring on loss of clock for a synchronous signal, to measure stability between a bus synchronous signal and a clock for matching data transmission-receiving with a higher accuracy.

2. Description of the Related Art

Depending on the kind of method used in data transmission, a communication system can be divided into synchronous transmission and asynchronous transmission. The synchronous transmission packs a predetermined number of character strings, not a character, in a bundle, and sends them at once. According to this method, a transmitting side and a receiving side, independently of data, are operated following a synchronizing signal as a reference clock. The receiving side defines a bit type according to a clock, so the synchronous transmission usually uses a duplex circuit for data and clock. When the transmitting side transmits binary data at a normal transmission rate, the receiving side recognizes the data per clock cycle. Although the synchronous transmission, compared to the asynchronous transmission, has higher transmission efficiency, it costs much because the receiving side should count bit and a separate memory unit is required for character assembly.

The asynchronous transmission, on the other hand, transmits data by including a synchronous signal in an editor. This method is performed independently of a transmitting signal of the transmitting side, and a character is transmitted one by one, followed by identifying time slot interval with a receiving signal clock. Generally, the character at this time constitutes 7-8 bits, and further added is start bit in front of the character and stop bit at the end. Since the spacing (or pitch) between the start bit and the stop bit varies, the asynchronous transmission method is more appropriate for irregular transmission. Moreover, an interface unit or connecting equipment used in the asynchronous transmission is very simple, thus cheaper than synchronous transmission equipment.

If a network is operated by a TDM (Time Division Multiplexing) exchange, it means input data is divided into segments, and each segment is allocated alternately in a hybrid signal before it is transmitted. In order to minimize data loss, the synchronous transmission method is primarily used.

### SUMMARY OF THE INVENTION

It is, therefore, an object of the present invention to provide an apparatus for monitoring clock in a data communication system, capable of more accurately checking abnormality in transmitting/receiving data between matching boards using a synchronous signal and a clock signal that are provided by an internal system bus in the data communication system, by managing state stability of the synchronous and clock signals in higher accuracy.

It is another object to provide an apparatus and technique for monitoring clock in a data communication system that is easy and inexpensive to implement.

It is yet another object to provide an apparatus and technique for monitoring clock in a data communication system that is more efficient.

To achieve the above and other objects, there is provided an apparatus for monitoring clock in a communication system for transmitting/receiving data, the apparatus including: a first buffer block for receiving a synchronous signal and a clock from a system bus and temporarily storing the synchronous signal and clock; a first counter block for counting system clock using the synchronous signal as a reference; a comparison block for latching a count value and comparing the count value to a reference value that is obtained from a normal operation; a pulse generation block for generating a designated number of pulses if the count value is not equal to the reference value at a result of comparison; a second counter block for counting a number of pulses generated by the pulse generation block during a monitoring cycle; and a second buffer block for storing a count value obtained at the second counter block and clearing the count value when a system control block (CPU) reads the count value.

Preferably, the first buffer block includes an AC (Alternating Current) termination circuit for receiving the synchronous signal and the clock more stably, the first counter block receives the synchronous signal to a clear part of the first counter block, the comparison block latches the count value obtained at the first counter block right before the count value is cleared, the pulse generation block generates one pulse if the count value is not equal to the reference value, the pulse generation block does not generate pulse if the count value is equal to the reference value, the monitoring cycle of the second counter block is set to 2.5 sec, and the second buffer block stores the number of pulses generated until the control block (CPU) reads the number.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram illustrating a clock signal monitoring apparatus in communication system according to a related art; and

FIG. 2 is a block diagram illustrating an apparatus for monitoring clock according to a preferred embodiment of the present invention.

### DETAILED DESCRIPTION OF THE PREFERRED EMBODIMENTS

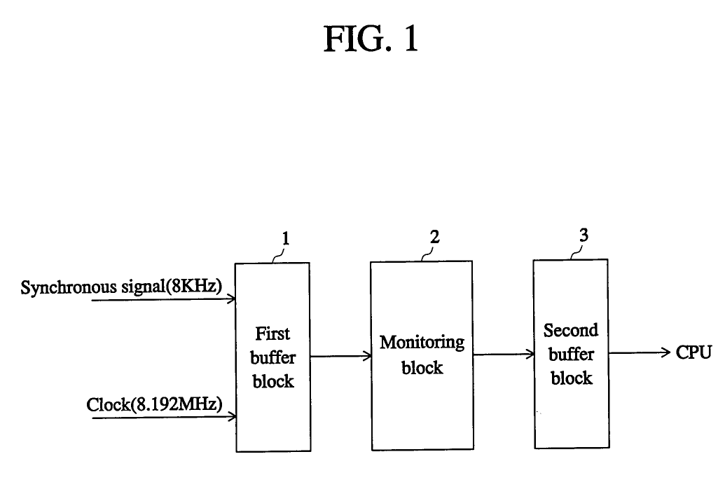

FIG. 1 is a block diagram illustrating a clock signal monitoring apparatus in communication system of a related art.

As illustrated in FIG. 1, the clock signal monitoring apparatus in communication system includes a first buffer block 1 for receiving synchronous signal and clock signal from a master unit (not shown) of system and for temporarily storing the synchronous signal and clock signal, a monitoring block 2 for monitoring the synchronous signal and clock signal in the first buffer block 1, and a second buffer block 3 for temporarily storing a monitored result from the monitoring block 2 and allowing the controlling block (CPU, central processing unit) (now shown) to read the result.

As for the monitoring block 2, a D flip-flop or bistable multivibrator is used. The monitoring block 2 simply checks whether or not a clock signal has been generated for a synchronous signal during a monitoring reference time.

Suppose that there is a system of which a synchronous signal provided from a system bus has a frequency of 8 KHz and a clock signal has a frequency of 8.192 MHz. To explain how the monitoring process is done in this particular system, the first buffer block 1 first receives the synchronous signal (8 KHz) and the clock signal. When the clock signal is generated 1024 times, the monitoring block 2 informs the second buffer block 3 that the clock signal has been generated. Then, the second buffer block 3 decides that the clock signal has been provided properly and informs this to the CPU (not shown).

However, even when the clock signal is generated less or more than 1024 times during the synchronous signal 8 KHz, the monitoring block 2, which only checks whether or not the clock signal has been generated, notifies the second buffer block 3 that the clock signal has been generated as normal. Hence, the second buffer block 3 concludes that the clock signal generation has been completed properly and informs the CPU (not shown) as such.

In other words, although there might be an error in the system synchronous signal and clock signal, the monitoring block of the related art is not able to detect the error but recognizes it as a normal state as long as the clock signal is generated. Therefore, it was common to lose data when transmitting/receiving data using the above system, and it was not clear either whether data loss was caused by the error in the clock signal. In short, a major problem of the related art is that it was impossible to accurately identify the cause of any problem.

A preferred embodiment of the present invention will be described herein below with reference to the accompanying drawings. In the following description, well-known functions or constructions are not described in detail since they would obscure the invention in unnecessary detail.

The following description is based on an assumption that a system bus provides an 8 KHz synchronous signal and an 8.192 MHz clock.

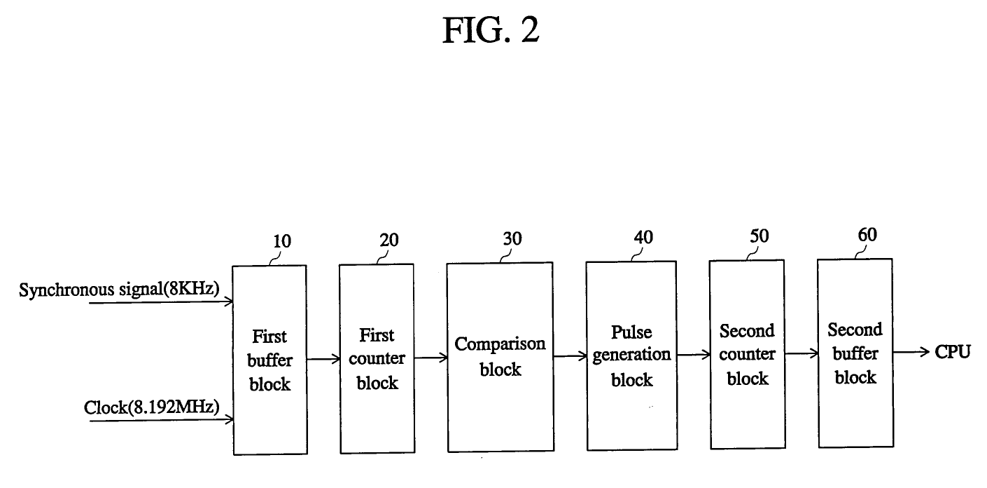

FIG. 2 is a block diagram showing an apparatus for monitoring clock according to a preferred embodiment of the present invention.

As illustrated in FIG. 2, the apparatus for monitoring clock in data communication system includes a first buffer block 10, a first counter block 20, a comparison block 30, a pulse generation block 40, a second counter block 50, and a second buffer block 60.

The first buffer block 10 receives a synchronous signal (8 KHz) and clock (8.192 MHz) from a system bus, and temporarily stores them.

The first counter block 20 receives the system bus synchronous signal to a clear part of the first counter block of the counter, and counts a system clock using the synchronous signal as a reference. As aforementioned, particularly 8 KHz synchronous signal and 8.192 MHz clock are used in the embodiment. This means that during 8 KHz section, count value for 8.192 MHz clock is repeatedly found between ‘0’ and ‘1024’.

The comparison block 30 latches the count value right before it is cleared up, and compares the value to a reference value (1024) that is obtained from a normal operation, and if the count value is the same with the reference value, outputs ‘0’ and if the count value is different from the reference value, outputs ‘1’.

The pulse generation block 40 receives the value ‘1’ from the comparison block 30 in case the count value is not the same with the reference value (1024), and generates a pulse. In like manner, the pulse generation block 40 receives the value ‘0’ from the comparison block 30 in case the count value is equal to the reference value, and does not generate pulse.

The second counter block 50 counts the number of pulses that are generated by the pulse generation block 40 during monitoring cycle (e.g. 2.5 sec (seconds)), and provides the result to the second buffer block 60.

The second buffer block 60 stores the count value provided by the second counter block 50, and simultaneously, as the system control block (CPU) reads the value, the second buffer block 60 clears the value for monitoring during a next cycle.

On the other hand, when the clock from the system bus (not shown) turns out to be abnormal, it is highly possible that the first counter block 20 yields a different count value from the normal one (i.e. reference value ‘1024’). Therefore, the comparison block 30 outputs the value ‘1’ to the pulse generation block 40.

The moment the pulse generation block 40 receives the value ‘1’, it generates a pulse, and the second counter block 50 counts the number of pulses generated at this time.

During the monitoring cycle, the number of pulses generated by the pulse generation block 40 is counted, and this number becomes a clue for more accurately detecting how many times the clock has been lost. The second buffer block 60 then stores the number of occurrences of clock loss, and the CPU (central processing unit) reads out the number and figures out (determines) the present stability of clock of the system more accurately.

The moment the CPU reads the result of clock loss, the second buffer block 60 is cleared and gets ready to repeat the above procedure.

As discussed before, when 8 KHz synchronous signal and 8 MHz clock are used, the first counter block 20 counts the number of 8.192 MHz during the 8 KHz section, and as a result, the reference value ‘1024’ is obtained. However, if the synchronous and clock signals have different frequencies, the reference value would be different for each system.

The present invention can also be realized as computer-executable instructions stored in computer-readable media. The computer-readable media includes all possible kinds of recording media in which computer-readable data is stored. The computer-readable media include storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), system memory (read-only memory, random access memory), flash memory, and carrier waves (e.g., transmission via the Internet). Also, the computer-readable media can store and execute computer-readable codes that are distributed in computers connected via a network.

In conclusion, the present invention can be advantageously used for more accurately identifying the cause of data loss and measuring the stability of synchronous and clock signals in system, by checking or monitoring any occurrence of clock loss using the synchronous signal as a reference and providing this monitoring result to the system control block (i.e. CPU).

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

What is claimed is:

1. An apparatus for monitoring clock in a communication system for transmitting and receiving data, the apparatus comprising:
a first buffer block for receiving a synchronous signal and a clock from a system bus and temporarily storing the synchronous signal and clock;
a first counter block for counting system clock using the synchronous signal as a reference;
a comparison block for latching a count value and comparing the count value to a reference value that is obtained from a normal operation;
a pulse generation block for generating a designated number of pulses when the count value is not equal to the reference value at a result of comparison;
a second counter block for counting a number of pulses generated by the pulse generation block during a monitoring cycle; and
a second buffer block for storing a count value obtained at the second counter block and clearing the count value when a system control block reads the count value.

2. The apparatus according to claim 1, wherein the first buffer block comprises an alternating current termination circuit for receiving the synchronous signal and the clock more stably.

3. The apparatus according to claim 1, wherein the first counter block receives the synchronous signal to a clear part of the first counter block.

4. The apparatus according to claim 1, wherein the comparison block latches the count value obtained from the first counter block right before the count value is cleared.

5. The apparatus according to claim 1, wherein the pulse generation block generates one pulse when the count value is not equal to the reference value.

6. The apparatus according to claim 1, wherein the pulse generation block does not generate pulse when the count value is equal to the reference value.

7. The apparatus according to claim 1, wherein the monitoring cycle of the second counter block is set to 2.5 seconds.

8. The apparatus according to claim 1, wherein the second buffer block stores the number of pulses generated until the control block reads the number.

9. The apparatus according to claim 1, wherein the system control block is a central processing unit.

10. The apparatus according to claim 1, further comprised of the first counter block determining the reference value according to the synchronous signal and clock.

11. A method for monitoring clock in a communication system for transmitting and receiving data, the method comprising:
receiving a synchronous signal and a clock from a system bus and temporarily storing the synchronous signal and clock by a first buffer block;
counting system clock using the synchronous signal as a reference by a first counter block;
latching a count value and comparing the count value to a reference value that is obtained from a normal operation by a comparison block;
generating a designated number of pulses when the count value is not equal to the reference value at a result of comparison by a pulse generation block;
counting a number of pulses generated by the pulse generation block during a monitoring cycle by a second counter block; and
storing a count value obtained at the second counter block and clearing the count value when a system control block reads the count value by a second buffer block.

12. The method according to claim 11, wherein the first buffer block comprises an alternating current termination circuit for receiving the synchronous signal and the clock more stably.

13. The method according to claim 11, wherein the first counter block receives the synchronous signal to a clear part of the first counter block.

14. The method according to claim 11, wherein the comparison block latches the count value obtained from the first counter block right before the count value is cleared.

15. The method according to claim 11, wherein the pulse generation block generates one pulse when the count value is not equal to the reference value.

16. The method according to claim 11, wherein the pulse generation block does not generate pulse when the count value is equal to the reference value.

17. The method according to claim 11, wherein the monitoring cycle of the second counter block is set to 2.5 seconds.

18. The method according to claim 11, wherein the second buffer block stores the number of pulses generated until the control block reads the number.

19. A computer-readable medium having computer-executable instructions for performing a method, comprising:
receiving a synchronous signal and a clock from a system bus and temporarily storing the synchronous signal and clock by a first buffer block;
counting system clock using the synchronous signal as a reference by a first counter block;
latching a count value and comparing the count value to a reference value that is obtained from a normal operation by a comparison block;
generating a designated number of pulses when the count value is not equal to the reference value at a result of comparison by a pulse generation block;
counting a number of pulses generated by the pulse generation block during a monitoring cycle by a second counter block; and
storing a count value obtained at the second counter block and clearing the count value when a system control block reads the count value by a second buffer block.

20. A computer-readable medium having stored thereon a data structure comprising:
a first field containing data representing a first buffer block receiving a synchronous signal and clock from a system bus, and storing the synchronous signal and clock signal;
a second field containing data representing a first counter block receiving the system bus synchronous signal to a clear part of the first counter block of a counter, and counting a system clock using the synchronous signal as a reference, the first counter block determining the reference value according to the synchronous signal and clock;
a third field containing data representing a comparison block latching the count value right before the count value is cleared up, and comparing the value to a reference value obtained from a normal operation, and when the count value is the same as the reference value, the comparison block outputting ‘0’ and when the count value is different from the reference value, the comparison block outputting ‘1’;
a fourth field containing data representing a pulse generation block receiving the value ‘1’ from the comparison block when the count value is not the same with the reference value, and generating a pulse and the pulse generation block receiving the value ‘0’ from the comparison block when the count value is equal to the reference value, and does not generate a pulse;
a fifth field containing data representing a second counter block counting the number of pulses that are generated by the pulse generation block during monitoring cycle, and providing the result to the second buffer block; and
a sixth field containing data representing a second buffer block storing the count value provided by the second counter block, and simultaneously, as the system control block reads the value, the second buffer block clearing the value for monitoring during a next cycle;
a seventh field containing data representing the comparison block outputs the value ‘1’ to the pulse generation block when the first counter block generating a value different from the reference value;
a eighth field containing data representing the pulse generator generating a pulse the moment the pulse generation block receives the value ‘1’, and the second counter block counting the number of pulses generated at this time, during the monitoring cycle, the number of pulses generated by the pulse generation block is counted, and the counted number of pulses accommodates a detection of how many times the clock has been lost; and
a ninth field containing data representing the second buffer block storing the number of occurrences of clock loss, and the control block reading out the number and determining the present stability of clock of the system.
